(19) United States
(12) Patent Application Publication
(10) Pub. No.: US 2003/0082440 A1
(43) Pub. Date: May 1, 2003

(54) Battery system

(75) Inventors: Edward N. Mrotek, Grafton, WI (US); Majid Taghikhani, Franklin, WI (US); William J. Wruck, Whitefish Bay, WI (US); Jason E. Muhammad, Milwaukee, WI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/021,731

(22) Filed: Oct. 29, 2001

(51) Int. Cl. H01M 10/48

(52) U.S. Cl. 429/123; 429/7; 429/177; 429/185; 429/90

(57) ABSTRACT

A battery cover system provides secure attachment between an electronic device and a battery terminal. A housing element includes a connector attached to the housing element and configured for electrical attachment to a battery terminal. The housing element also includes an electronic device attached to the housing element and to the connector. The connector may thus be attached to the battery terminal to provide a secure electrical contact throughout the life of the battery.

### BACKGROUND OF THE INVENTION

The present invention relates generally to the field of storage batteries, such as storage batteries used in automobiles or other vehicles. More specifically, the present invention relates to a battery cover system that includes at least one connector for maintaining a secure electrical connection between an electronic device and a battery terminal.

Electronic devices, such as anti-theft or other devices, may be included in a battery. The electronic devices may be attached to a battery housing component and manufactured as original equipment with the battery or added to a battery after the manufacturing process is complete, such as with aftermarket components. These electronic devices require an electrical power source in operation, such as electrical power received from an attachment of the electronic device to the terminals of the battery. For the electronic devices to function throughout the service life of the battery, it is necessary to maintain an electrical connection to the power source.

Accordingly, it would be advantageous to provide a battery cover system that includes attached electronic devices and that may be installed on a storage battery. It would also be advantageous to provide a battery cover system having attached electronic devices that may be securely attached to the terminals of a battery. It would further be advantageous to provide a battery cover system that maintains an electrical connection between an electronic device and a battery terminal throughout the service life of a battery. It would further be advantageous to provide a battery cover system that maintains an electrical connection between an electronic device and a battery terminal despite dimensional changes (e.g., warpage, shrinkage, expansion, etc.) of various components of the battery due to heat, corrosion, or other conditions that occur during the operating or service life of the battery. It would further be advantageous to provide a battery cover system that may be relatively simply installed on a storage battery. It would further be advantageous to provide a battery cover system that is relatively inexpensive to produce, and that may be manufactured in an efficient manner.

It would be desirable to provide a system having any one or more of these or other advantageous features.

### SUMMARY OF THE INVENTION

The present invention relates to an apparatus for providing an electrical and mechanical connection between an electronic device and a battery terminal. The apparatus includes a clip coupled to a battery terminal and at least one electronic device included in a battery.

The present invention also relates to a storage battery module. The storage battery module includes a housing element and a connector attached to the housing element and configured for electrical attachment to a battery terminal. The storage battery module also includes an electronic device attached to the housing element and to the connector.

The present invention further relates to a housing element for use with a battery. The housing element includes a cover configured for attachment to a battery and at least one electronic device attached to the cover. The housing element also includes at least one connector attached to the cover and configured for coupling the electronic device to a battery terminal.

The present invention further relates to a battery. The battery includes a first housing element and a second housing element attached to the first housing element. The second housing element includes at least one electrical circuit. The housing element also includes at least one resiliently flexible connector attached to the second housing element and configured for coupling the circuit to a battery terminal.

The present invention further relates to a storage battery including a system for monitoring a state of the battery. The storage battery includes a first cover and a second cover coupled to the first cover. The second cover includes an electronic device, and a wire is coupled to the electronic device. The battery also includes at least one clip coupled to the wire and to a secondary battery terminal.

### BRIEF DESCRIPTION OF THE DRAWINGS

FIG. 1 is a perspective view of a storage battery according to an exemplary embodiment.

FIG. 2 is a bottom plan view of a cover and electronic device for use with the storage battery shown in FIG. 1.

FIG. 3 is a fragmentary exploded perspective view of the storage battery shown in FIG. 1.

FIG. 4 is a cross-sectional view of the storage battery shown in FIG. 1, taken along line 4-4 in FIG. 1.

FIG. 5 is a perspective view of a connector for use with the storage battery shown in FIG. 1.

FIG. 6A is a fragmentary exploded sectional view of the storage battery shown in FIG. 1, illustrating a cover and battery in an unassembled configuration.

FIG. 6B is a fragmentary sectional view of the storage battery shown in FIG. 1, illustrating a cover and battery in an assembled configuration.

FIG. 7 is a fragmentary sectional view of the storage battery shown in FIG. 1, taken along line 7-7 in FIG. 6B.

FIG. 8A is a fragmentary sectional view of a storage battery according to an alternative embodiment.

FIG. 8B is a fragmentary sectional view of a storage battery according to an alternative embodiment.

FIG. 8C is a fragmentary sectional view of a storage battery according to an alternative embodiment.

### DETAILED DESCRIPTION OF THE PREFERRED EMBODIMENTS

Referring to FIGS. 1-3, a battery 10 according to an exemplary embodiment is shown. Battery 10, shown as a storage battery, includes a battery housing or container 12. Battery 10 also includes a primary housing element or cover 14 attached to container 12 and a secondary housing element or cover 20 attached to primary cover 14 or to container 12. Primary cover 14 may have a shape complementary to that of container 12. In the exemplary embodiment shown in FIG. 1, container 12 has a generally rectangular shape and primary cover 14 has a matching rectangular shape.

Primary cover 14 may be relatively permanently attached to container 14 about the edges of primary cover 14. The permanent attachment may be accomplished using an adhesive, heat seal, ultrasonic or vibration welding, or other similar fastening methods. For example, where both primary cover 14 and container 12 are formed from a polymeric material, a portion of primary cover 14 and container 12 may be melted together to connect the two components. According to an alternative embodiment, the primary cover and container are integrally formed as a single piece. In yet another alternative embodiment, the primary cover may be non-permanently attached to the container, as by a snap or press fit.

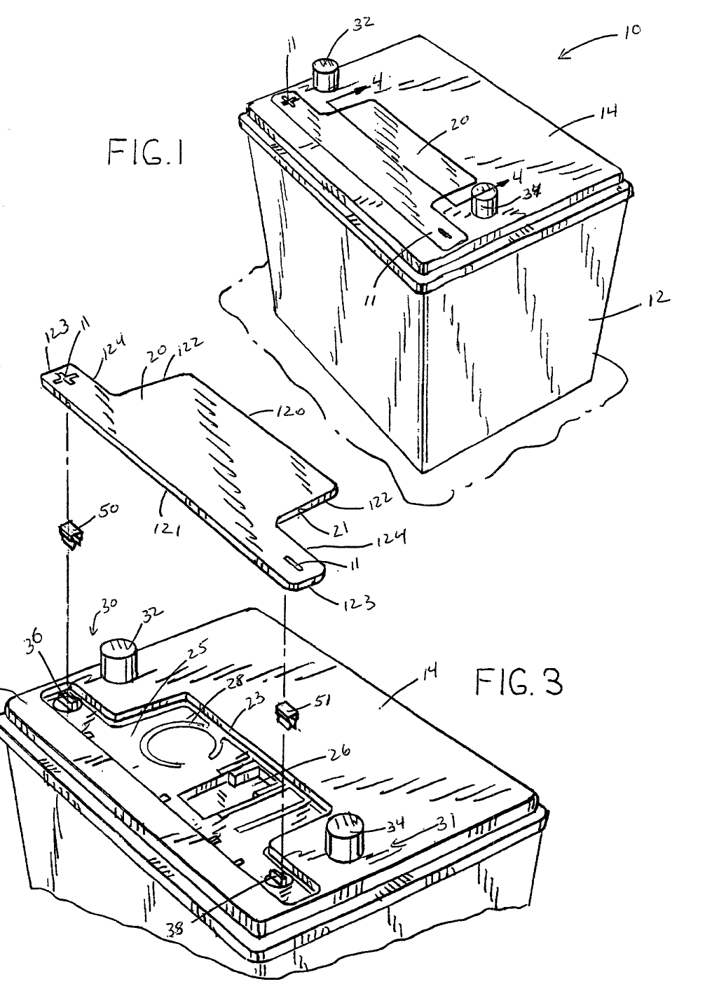

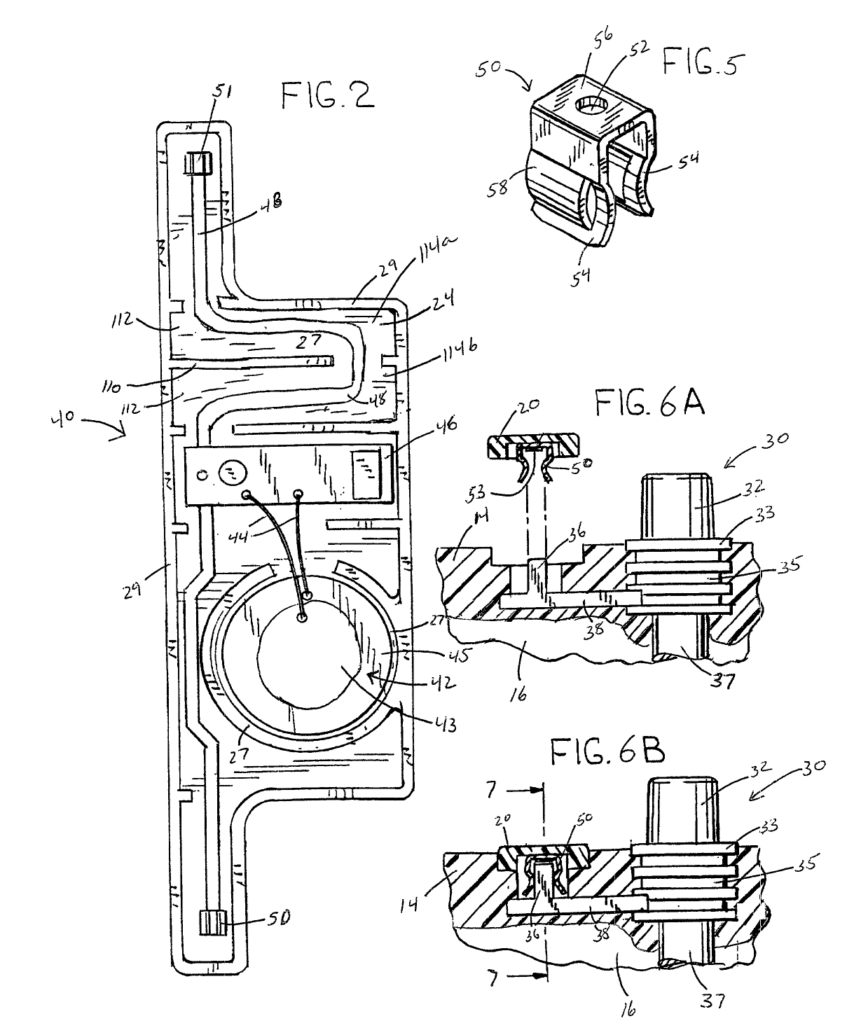

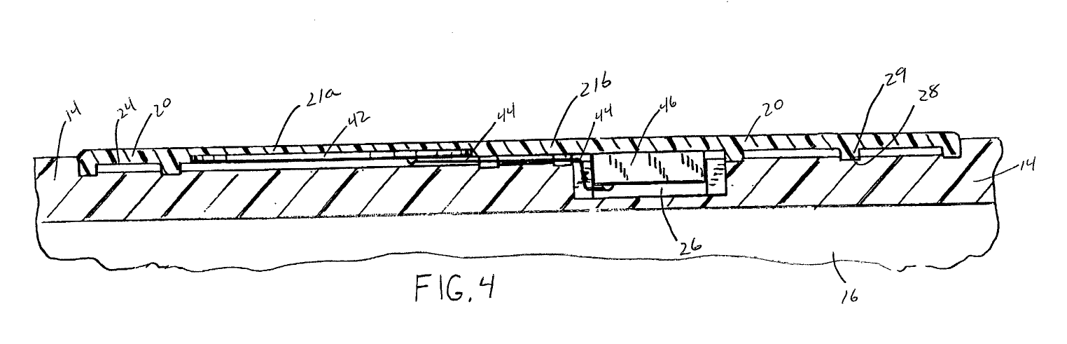

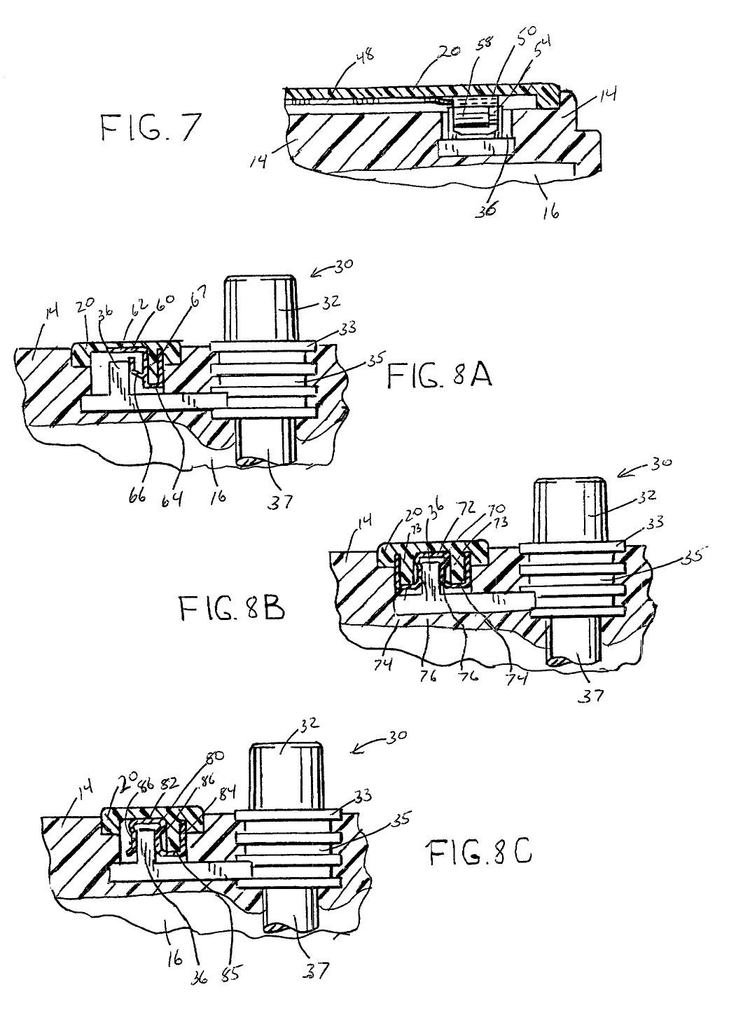

Battery 10 includes a positive battery terminal or post 32 and a negative battery terminal or post 34 extending from the surface of primary cover 14. When battery 10 is installed in a vehicle, cables or wires may be connected to each of terminals 32, 34 to provide electrical power to the vehicle electrical or starter system. Battery terminals 32, 34 may be part of a bushing assembly or bushing 30, 31. As shown in FIGS. 3 and 6A, bushing 30 includes a member 38, shown as an extension or flange, that couples a secondary terminal or post 36 to terminal 32. In an exemplary embodiment, terminal 32, flange 38, and secondary terminal 36 are made of a lead alloy and are formed as a single component. For example, terminal 32, flange 38, and secondary terminal 36 may be cast together in a single forming operation. According to an alternative embodiment, one or more of the bushing components (i.e., terminal, flange, and secondary terminal) may be formed separately and attached to the other component or components.

Terminal 32 (and similarly terminal 34) also may include a plurality of lands 33 and grooves 35 to provide secure coupling of terminal 32 to primary cover 14. While FIG. 6A illustrates four lands 33 and three grooves 35 in battery terminal 30, any number or configuration (e.g., shape, size, arrangement, etc.) of lands and grooves may be used. In an exemplary embodiment, terminal 30 may be connected or fused to cover 14 using an auto post burn (APB) process. In an alternative embodiment, the terminal may have a smooth surface, such that the terminal may be press or snap fit into an opening in the primary cover. In other alternative embodiments, the terminal may be provided with any of a variety of surface features that may provide secure coupling between the terminal and primary cover. Terminal 32 also may include an extension 37 that extends into the interior 16 of battery 10. As shown, extension 37 is a lead post connected to a battery strap and provides electrical power to terminal 30.

As shown in FIG. 2, secondary cover 20 includes one or more electronic devices or electrical systems 40, which may in turn include at least one electrical circuit. In an exemplary embodiment, a controller 46 (e.g., a microprocessor, one time programmable (OTP) microprocessor, programmable logic chip (PLC), chip, application specific integrated circuit (ASIC), printed circuit board, or the like) is connected by one or more wires 44 to a display or alarm 42 which may provide a signal (e.g., visual and/or audible) representative of a condition of the vehicle (e.g., ignition has occurred and the vehicle engine is running) or the battery (e.g., state of charge, state of health, capacitance, deliverable energy or power, temperature, voltage, current, life, etc.). When a certain condition is met, such as when the stored charge drops below a certain threshold, controller 46 may activate alarm 42 to alert a driver or passenger of a vehicle that battery 10 requires repair, maintenance, or other action. Controller 46 may also be configured to calculate when battery 10 is close to failure, and predict the amount of time remaining in the life of the battery. In alternative embodiments, other electronic devices may be provided in the secondary cover. For example, an anti-theft device such as a warning device or battery shut off device may be included in a secondary cover. In another example, an electronic device may be configured to disconnect or reconnect a battery or individual loads connected to the battery in response to various inputs, such as the turning of an ignition switch or an indication from a device that registers the presence of a person in the driver's seat. Electronic device 40 may comprise any number and type of components. For example, the electronic device may include both a battery state-of-charge monitor and an anti-theft device. According to a preferred embodiment, each side of the controller has a polarity (e.g., “handed” or chiral), such that the controller may be positioned or oriented so that a positive end is near the alarm. According to an alternative embodiment, the controller may include a mechanical or electronic sense to allow for polarity reversal and to allow the controller to be installed in a manner without regard to polarity.

According to a preferred embodiment as shown in FIG. 2, alarm 42 is a piezo having an active lead-based material shown as a central disk 43 surrounded by an electrode ring 45. Alarm 42 is secured to a diaphragm portion 21a of secondary cover 20 by a fastener. According to a preferred embodiment, the fastener is a double coated urethane foam tape having a model number 4032 or 4932 and commercially available from 3M Company of St. Paul, Minn. The fastener preferably has a ring shape and a thickness of less than about 30 mil. The fastener provides a space or resonance cavity (speaker) between the alarm and the secondary cover. Diaphragm 20a has a thickness less than the thickness of secondary cover (compare thickness of diaphragm 21a to wall 21b in FIG. 4). According to a particularly preferred embodiment, the wall of the secondary cover has a thickness of at least about 90 mil.

Alarm 42, and diaphragm 20a, expand and contract relative to the fastener (e.g., a pivot point) in response to a voltage applied by controller 46. Such expansion and contraction provides a signal (e.g., audible “chirp” or warning) representative of a condition of the battery. The alarm provides a signal in a range that is perceptible to humans (e.g., about 2-2.5 kHz) at an audible level when the battery is installed in a vehicle (e.g., greater than about 105 decibels a point 10 cm from the alarm). According to a particularly preferred embodiment, the piezo is a 41 mm diameter piezo element having model number CB-4108 BA commercially available from Dae Young Electronic Company, Ltd. of Kyung-Buk, Korea. In an alternative embodiment, the piezo is a 41 mm diameter disc bender having model number 2-411011 and commercially available from APC International Ltd. of Duck Run, Pa.

Electronic device 40 may be attached to secondary cover 20 by any of a variety of methods, such as by adhesive, snap or press fit, contact cement, or otherwise mechanically fastening the device components to secondary cover 20. According to an alternative embodiment, a metal or plastic pin of the secondary cover can penetrate the electronic device (and may be “mushroomed” or deformed) to establish the connection between the electronic device and the secondary cover.

One or more of the electronic device components may be partially or completely surrounded by a raised member 29, shown as a wall or frame, extending outward from the interior surface 24 of secondary cover 20. Frame 29 may define or surround one or more pockets or chambers 27, shown as recesses or pockets, in secondary cover 20. A groove or channel 28 complementary to frame 29 may be provided in primary cover 14, such that groove 28 aligns with frame 29 when secondary cover 20 is attached to primary cover 14. Groove 28 may define or surround one or more slots or openings 26 in primary cover 14. Pockets 27 and openings 26 may contain one or more components of electronic device 40. FIG. 4 is a cutaway side view taken along line 4-4 in FIG. 1 showing secondary cover 20 installed on primary cover 14 according to an exemplary embodiment. With secondary cover 20 installed on primary cover 14, chip 46 extends into opening 26 in primary cover 14. Frame 29 is received within groove 28 and at least partially surrounds various components, such as alarm 42 and chip 46. According to a preferred embodiment, the electronic devices are installed on the secondary cover; the electronic device, wires, and connectors are tested; and then the secondary cover is attached to the primary cover.

Connectors 50, 51, shown as clips, are included in secondary cover 20 for providing electrical and physical connection between electronic device 40 and secondary battery terminals 36, 38. The size, shape, and configuration of clips 50, 51 may vary depending on various design considerations. For example, clips 50, 51 may be spring clips formed from a thin piece of metal. In an exemplary embodiment, clips 50, 51 include a substantially flat top portion or tab 56 having a hole or aperture 52 formed therein. At least one extension or leg 54 may extend from top portion 56, and may include a convex reinforcement member 58. As illustrated in FIG. 5, clip 50 includes two legs 54 extending from top portion 56. Legs 54 may be resiliently flexible members. In a particularly preferred embodiment, clips 50, 51 are 2 AG/5 mm surface mount fuse clips commercially available from Keystone Electronics Corporation of Astoria, N.Y. In this embodiment, clips 50, 51 are made of tin plated brass, and the thickness of the various clip components (legs, top portion, etc.), is approximately 0.016±0.01 inches.

In an exemplary embodiment, clips 50, 51 are attached or coupled to secondary battery terminals 36, 38. Clips 50, 51 are also attached or coupled to a wire or conductive trace 48, which is in turn attached or coupled to electronic device 40. In this manner, power may be supplied to chip 46 or to other components of electronic device 40. Coupling electronic device 40 to secondary battery terminals 36, 38 may also provide other inputs to electronic device 40. For example, electronic device 40 may measure the time rate of discharge of battery 10 by measuring the voltage or current across secondary terminals 36, 38. Electronic device 40 may be configured for responding, measuring, or analyzing voltage or current drops or fluctuations. For example, electronic device 40 may be configured for recognizing a waveform produced by current fluctuations characteristic of an operating vehicle engine.

Clips 50, 51 may be configured for providing at least some mechanical coupling between secondary cover 20 and secondary battery terminals 36, 38. In an exemplary embodiment, clips 50, 51 are configured for providing a relatively secure attachment with secondary battery terminals 36, 38, such that clips 50, 51 will not be jostled, shaken free, or otherwise detached from secondary terminals 36, 38 during operating or service conditions of battery 10. Legs 54 include a resiliently flexible or spring-like property, such that legs 54 are biased toward each other, but do not necessarily exert a vertical force to push the primary cover away from the secondary cover. The inward curvature of legs 54 illustrated in FIG. 5 may allow a portion of legs 54 to act as a stop or catch to prevent or limit horizontal movement of the clip when it is installed on a battery terminal. Convex member 58 may be configured for providing additional resiliency or force to the springing action of legs 54. It is intended that using a resiliently flexible clip will allow an electrical connection to be maintained even where operating conditions cause the secondary cover to expand, contract, warp, or otherwise deform due to heat, cold, pressure, and the like. Additionally, clips 50, 51 may be configured for providing electrical connection regardless of the character of deformation of secondary cover 20 (e.g., left to right or front to back warpage). It is thus intended that various deformations of secondary cover 20 may be accommodated without losing electrical contact. According to an alternative embodiment, the clips provide a sufficient mechanical connection between the primary cover and the secondary cover during a welding or heat sealing step without the use of additional fasteners.

FIGS. 6A and 6B show clip 50 being installed on secondary battery terminal 36, and FIG. 7 is a cutaway side view of battery 10 taken along line 7-7 in FIG. 6B showing clip 50 and secondary cover 20 installed on battery 10. Before clip 50 is connected to secondary battery terminal 36 in FIG. 5A, legs 54 extend from top portion 56 in a first position. As clip 50 is positioned on secondary battery terminal 36 in FIG. 5B, legs 54 flex or deform away from each other. Since legs 54 are biased toward each other, legs 54 grip the sides of secondary battery terminal 36. In this manner, legs 54 may provide a relatively secure connection between clip 50 and secondary battery terminal 36.

The amount of gripping or holding force applied by legs 54 against secondary battery terminal 36 may be adjusted depending on various design considerations. For example, increasing the amount of material used in legs 54 or using a more rigid material to form clip 50 may act to increase the amount of holding or gripping force. Where clips 50, 51 are responsible for providing secure attachment between primary cover 14 and secondary cover 20, clips 50, 51 may be configured to provide a larger force. Where primary cover 14 and secondary cover 20 are secured together by other means, such as by heat sealing secondary cover 20 to primary cover 14, clips 50, 51 may be configured to provide a smaller force.

While clips 50, 51 have been described and shown as having a pair of flexible legs 54 extending from a generally flat top portion 56, other designs and configurations for connectors 50, 51 may also be used. FIGS. 8A through 8C show several alternative embodiments of clips 50, 51. In FIG. 8A, a connector 60 includes a generally flat top portion 62 and a U-shaped body member 64. U-shaped body member 64 is configured for attachment to an extension 67 formed in secondary cover 20. Thus, both flat top portion 62 and U-shaped body member 64 may be mechanically attached to secondary cover 20. A resiliently flexible member 66 may extend from U-shaped member 64. Flexible member 66 may be configured for abutting secondary terminal 36 when secondary cover 20 is attached to primary cover 14. Thus, as secondary cover 20 is attached to battery 10, flexible member 66 flexes or bends inward toward extension 67. Since flexible member 66 is biased away from extension 67, member 66 is forced against secondary terminal 36. Connector 60 may be made from a conductive metal, and may be attached via wire 48 to electronic device 40.

In another alternative embodiment shown in FIG. 8B, a connector 70 may include a generally flat top portion 72 and a pair of generally U-shaped members 74 attached to top portion 72. U-shaped members may be configured for attachment to a pair of extensions 73 formed in secondary cover 20. Flexible members 76 included in U-shaped members 74 may extend outward from extensions 73, and may be biased outward from extensions 73 and toward each other. When connector 70 is attached to secondary terminal 36, flexible members 76 may flex inward toward extensions 73. The outward biasing of flexible members 76 forces flexible members 76 against the sides of secondary terminal 36, providing a relatively secure electrical connection between secondary terminal 36 and electronic device 40.

Another alternative embodiment is shown in FIG. 8C. A connector 80 includes a generally flat top portion 82 and a generally U-shaped member 84 configured for attachment to an extension 85 formed in secondary cover 20. Connector 80 also includes a pair of flexible members 86 biased toward each other and configured for providing a relatively secure attachment to secondary terminal 36. Attaching connector 80 to secondary terminal 36 forces flexible members 86 apart, and the biasing of flexible members 86 toward each other forces flexible members 86 against the side of secondary terminal 36.

Clips 50, 51 may be secured to secondary cover 20 in any of a variety of ways. In an exemplary embodiment, wire 48 is glued or otherwise fastened to secondary cover 20, and clips 50, 51 are soldered to wire 48. In an alternative embodiment, another mechanical fastener 53, such as a weld, bolt and nut, screw, pin, contact cement, or other fastener such as a thermo lock resin, double sided tape, adhesive, etc. may be used to connect wire 48 and clips 50, 51 to secondary cover 20. In another alternative embodiment, clips 50, 51 may be connected directly to secondary cover 20. In this embodiment, clips 50, 51 may be fastened to secondary cover 20 using adhesive or other mechanical means, such as by a bolt and nut. Wire 48 may be attached to any surface of clips 50, 51, including the top or bottom surface of top portion 56. In an alternative embodiment, clips 50, 51 may be integrally formed with secondary cover 20. Thus, at least a portion of clips 50, 51 may be made of the same material as secondary cover 20. In another alternative embodiment, the clips may be integrally formed with the wire such that the clips and wire form a single component.

Clips 50, 51 and wire 48 may be made at least in part of a conductive material. Conductive metals such as copper, steel, brass, tin, and aluminum alloys may be used to form clips 50, 51 and wire 48. In an exemplary embodiment, clips 50, 51 are formed from tin or a tin alloy. For example, clips 50, 51 may be made of a tin/lead alloy or tin plated brass. According to an alternative embodiment, the clips may be covered with an electrically conductive “electro grease” or epoxy to reduce the likelihood of corrosion by acid. Different materials may also be used to form clips 50, 51 and wire 48. For example, clips 50, 51 may be made of brass, while wire 48 may be made of copper. Clip 50 may be made of the same or a different material than clip 51. In an exemplary embodiment, clips 50, 51 and wire 48 are made entirely of a conductive material. In an alternative embodiment, only a portion of the clips or wire are made of a conductive material. For example, a portion of a clip may be made of a polymeric material such as polypropylene, while another portion of the clip may be made of copper. The copper portion may provide electrical contact between a secondary battery terminal and a wire, which may in turn provide an electrical connection to an electronic device. As such, the wire may be connected to the conductive material included in the clips. In this manner, the clips may be integrally formed with the secondary cover, with a conductive material added thereafter to promote electrical conduction between the electronic device and the secondary battery terminals. As shown in FIG. 2, wire 48 may follow a “tortuous” or “serpentine” path through an opening 112 of a partition 110. Partition 110 serves to form a reservoir or chamber for retaining fluid (e.g., acid) between the primary and secondary covers. For example, fluid in chamber 114a could not be provided to chamber 114b until reaching a maximum level or height. Accordingly, chamber 114a would retain a threshold amount of fluid before the fluid would be provided to chamber 114b.

Certain features of battery 10 may be described with regard to various exemplary and alternative embodiments. While container 12 is shown as having a generally rectangular solid shape with four side panels and a bottom portion, other shapes and configurations may also be used. For example, instead of having generally planar sides, the battery may include sides having rounded or curved features that protrude outward from the container. In another example, the side panels need not be substantially perpendicular to adjacent side panels, but may have a different angular relationship with adjacent side panels. The particular design for the container may vary depending on various design considerations, including the size or shape of battery components stored within the container, the size and shape of a vehicle compartment in which the battery is used, the location of battery terminals or arrangement of other battery components, or various other factors that may require alteration of the general size and/or shape of the container.

In an exemplary embodiment as shown in FIG. 3, primary cover 14 includes an opening 25 such as a molded opening for receiving secondary cover 20 therein (e.g., a nested configuration). Opening 25 may have a size and shape complementary to that of secondary cover 20, such that an outer edge or border 21 of secondary cover 20 abuts an interior edge or border 23 of opening 25. In an alternative embodiment, the secondary cover may have a size and shape different from that of the opening. For example, the secondary cover may be smaller than the opening, such that the edges of the opening and secondary cover are separated by a space. In another alternative embodiment, the primary cover may not be provided with an opening, and the primary cover may be attached to a surface of the primary cover. In a further alternative embodiment, more than one secondary cover may be provided in the battery. In this embodiment, a plurality of secondary covers may be received within a single opening. Alternatively, multiple openings may be provided for receiving a plurality of secondary covers.

Any number, size, shape, and arrangement of primary and secondary covers may be used without departing from the spirit and scope of the inventive concepts disclosed herein. As shown in FIG. 3, secondary cover 20 includes edges 120, 121, 122, 123, and 124. In a particularly preferred embodiment, edge 220 has a length of approximately 5 inches, edge 121 has a length of approximately 8.2 inches, edges 122 have lengths of approximately 1.55 inches, edges 123 have lengths of approximately 0.85 inches and edges 124 have lengths of approximately 1.6 inches. In an alternative embodiment, one or more of edges 120-124 may have different lengths. In another alternative embodiment, a secondary cover may be provided that has a different shape than that shown in FIG. 3, such as a rectangle, square, or any other shape.

Secondary cover 20 may be relatively permanently attached or coupled to primary cover 14. For example, secondary cover 20 may be attached to primary cover 14 by a heat seal between edge 21 and edge 23. In other exemplary embodiments, ultrasonic or vibration welding may be used to join the primary cover to the secondary cover. According to an alternative embodiment, the secondary cover and primary cover may be selectively melted together, as where portions of the primary and secondary covers are melted and the melted portions are joined together and cooled to form a solid couple between the components. In another alternative embodiment, the secondary cover may be non-permanently or selectively attached to the primary cover to allow removal of the secondary cover from the primary cover. For example, a snap or pressure fit may be used to secure the secondary cover to the primary cover. In another alternative embodiment, the primary cover and secondary cover need not be attached at their edges. In another alternative embodiment, the secondary cover may be a cover that is configured for attaching to the top of a battery after the battery has been produced. For example, a secondary cover may be attached to the top of a battery in a manner similar to the manner in which a box cover fits onto a box, wherein edges of the secondary cover extend downward along the sides of a battery. Other configurations are also possible that allow the secondary battery cover to be attached to a variety of different battery types. In this manner, the secondary cover may be designed as a universal attachment that may be adapted for use with batteries having a variety of shapes, sizes, and designs. Instead, a gap may exist between the edges, such that the secondary cover is attached to the primary cover in a different manner. In one example, a portion of the underside of the secondary cover may be attached, either permanently or nonpermanently, to a top surface of the primary cover, such as the surface of the opening.

While FIGS. 1 and 3 illustrate an exemplary embodiment in which both primary cover 14 and secondary cover 20 are attached to a top or upper surface of battery 10, other arrangements are also possible. In an alternative embodiment, one or both of the primary cover and secondary cover may be attached to one or more sides of the battery. For example, in a battery having terminals extending from a side of the battery, a primary and secondary cover may be provided on the side of the battery. In another alternative embodiment, one or both of the primary cover and secondary cover may be attached to both the top surface and one or more sides of the battery.

As shown in FIG. 3, each of secondary terminals 36, 38 has a size and shape configured for attaching to at least one connector or clip 50, 51. In an exemplary embodiment, secondary terminals 36, 38 include a hole or aperture in the top for receiving a male pin of a mounting device to hold a connector in place during attachment. Secondary terminals 36, 38 may extend into opening 25, as best shown in FIG. 3. In an exemplary embodiment, the top of secondary terminals 36, 38 do not extend substantially above the surface 15 of primary cover 14. In this manner, secondary cover 20 may be attached to primary cover 14 over secondary terminals 36, 38 such that the top surface of secondary cover 20 and primary cover 14 form a substantially planar surface. In an alternative embodiment, the secondary terminals may extend above the surface of the primary cover. In this embodiment, the secondary cover may either be flush with the surface of the primary cover or may be above the primary cover. In another alternative embodiment, the secondary terminals may extend through an aperture in the secondary cover.

Container 12 and primary cover 14 may be made of any polymeric material suitable for providing containment for interior components of a lead-acid battery, which may include an acid such as sulfuric acid and a plurality of lead alloy plates. For example, primary cover 14 may be made of polypropylene, polyethylene, or a copolymer containing polypropylene and/or polyethylene. Composite materials may also be used in forming container 12 and primary cover 14. In an exemplary embodiment, primary cover 14 and container 12 are formed by injection molding a copolymer containing polypropylene. Since secondary cover 20 is not in contact with interior components of a lead-acid battery, secondary cover 20 need not be formed from a material that is resistant to interior battery components. Secondary cover 20 may nevertheless be made of a polymeric material. Secondary cover may also be made from composite materials. The various components of battery 10 (e.g., container 12, primary cover 14, and secondary cover 20) may be made of different materials. For example, container 12 may be made of a polypropylene copolymer while primary cover 14 and secondary cover 20 may be made of polyethylene. Other material combinations are also possible.

Although the present invention has been described with reference to certain exemplary embodiments, those skilled in the art who review this disclosure will readily appreciate that many modifications are possible (e.g. variations in sizes, dimensions, structures, shapes and proportions of the various elements, values of parameters, mounting arrangements, use of materials, orientations, etc.) without materially departing from the novel teachings and advantages of the subject matter recited in the claims. Accordingly, all such modifications are intended to be included within the scope of the present invention as defined in the appended claims. Although certain embodiments may have been described as including one or more features providing one or more benefits, it is contemplated that the described features may be interchanged with one another or alternatively be combined with one another in the described preferred embodiments or in other alternative embodiments. Unless specifically otherwise noted, the claims reciting a single particular element also encompass a plurality of such particular elements. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit of the present inventions as expressed in the appended claims.

What is claimed is:

1. An apparatus for providing an electrical and mechanical connection between an electronic device and a battery terminal comprising:
a clip coupled to a battery terminal and at least one electronic device included in a battery.

2. The apparatus of claim 1, wherein the battery terminal is a secondary battery terminal.

3. The apparatus of claim 1, further comprising a first housing element and a second housing element, the second housing element attached to the electronic device.

4. The apparatus of claim 3, wherein the second housing element is attached to the first housing element.

5. The apparatus of claim 1, wherein the clip is configured for maintaining an electrical connection between the battery terminal and the electronic device.

6. The apparatus of claim 1, wherein the clip comprises at least one resiliently flexible member.

7. The apparatus of claim 1, wherein at least a portion of the clip is configured for flexing when the clip is attached to a battery terminal.

8. The apparatus of claim 1, wherein the clip is a spring clip formed from metal.

9. The apparatus of claim 1, wherein at least a portion of the clip is formed from a conductive material.

10. The apparatus of claim 1, further comprising a wire coupled to the clip and the electronic device.

11. The apparatus of claim 10, wherein the clip is integrally formed with one of the wire and a housing element.

12. A storage battery module comprising:
a housing element;
a connector attached to the housing element and configured for electrical attachment to a battery terminal; and
an electronic device attached to the housing element and to the connector.

13. The storage battery module of claim 12, wherein the housing element is configured for coupling to at least one of a battery container and another housing element.

14. The storage battery module of claim 12, wherein the housing element is coupled to at least one of a battery container and another housing element by at least one of a heat seal, an ultrasonic weld, and a vibration weld.

15. The storage battery module of claim 12, wherein the housing element is made from a polymeric material.

16. The storage battery module of claim 12, wherein the connector is configured for maintaining an electrical connection between the battery terminal and the electronic device.

17. The storage battery module of claim 12, wherein the connector comprises at least one resiliently flexible member.

18. The storage battery module of claim 12, wherein the connector is configured for flexing when the connector is attached to the battery terminal.

19. The storage battery module of claim 12, wherein the connector is formed from metal.

20. The storage battery module of claim 12, wherein at least a portion of the connector is formed from a conductive material.

21. The storage battery module of claim 12, further comprising a wire attached to the electronic device and the connector.

22. The storage battery module of claim 21, wherein the connector is integrally formed with the wire.

23. The storage battery module of claim 12, wherein the battery terminal is a secondary battery terminal, the second battery terminal being connected to a primary battery terminal.

24. The storage battery module of claim 12, wherein the electronic device comprises at least one of an alarm device, an anti-theft device, and a state-of-charge detection device.

25. The storage battery module of claim 12, wherein the electronic device is configured for monitoring a state of a battery.

26. The storage battery of claim 25, wherein the state of a battery is the amount of stored charge in a battery.

27. A housing element for use with a battery comprising:
a cover configured for attachment to a battery;
at least one electronic device attached to the cover; and
at least one connector attached to the cover and configured for coupling the electronic device to a battery terminal.

28. The housing element of claim 27, wherein the cover is attached to a battery by least one of a heat seal, an ultrasonic weld, and a vibration weld.

29. The housing element of claim 27, wherein the cover is made from a polymeric material.

30. The housing element of claim 27, wherein the connector comprises at least one flexible member.

31. The housing element of claim 27, wherein at least a portion of the connector is configured for flexing when the connector is attached to a battery terminal.

32. The housing element of claim 27, wherein at least a portion of the connector is formed from a conductive material.

33. The housing element of claim 27, further comprising a wire attached to the electronic device and the connector.

34. The housing element of claim 33, wherein the connector is integrally formed with the wire.

35. The housing element of claim 27, wherein the electronic device comprises at least one of a state of health detection device, an alarm device, an anti-theft device, and a state of charge detection device.

36. The housing element of claim 27, wherein the electronic device is configured for monitoring a state of a battery.

37. A battery comprising:
a first housing element;
a second housing element attached to the first housing element, the second housing element including at least one electrical circuit; and
at least one resiliently flexible connector attached to the second housing element and configured for coupling the circuit to a battery terminal.

38. The battery of claim 37, wherein the second housing element is attached to the first housing element by a heat seal.

39. The battery of claim 37, wherein both the first and second housing elements are made of a polymeric material.

40. The battery of claim 37, wherein the resiliently flexible connector is configured for maintaining an electrical connection between the battery terminal and the electrical circuit.

41. The battery of claim 37, wherein the resiliently flexible connector is configured for maintaining electrical contact during operation of a battery.

42. The battery of claim 37, wherein the resiliently flexible connector is configured for flexing when the connector is attached to a battery terminal.

43. The battery of claim 37, wherein at least a portion of the resiliently flexible connector is made of a conductive material.

44. The battery of claim 37, further comprising a wire attached to the electrical circuit and the connector.

45. The battery of claim 44, wherein the resiliently flexible connector is integrally formed with the wire.

46. The battery of claim 37, wherein the electrical circuit is configured for monitoring a state of a battery.

47. The battery of claim 37, wherein the electrical circuit forms a part of at least one of an alarm device, an anti-theft device, a state of health monitoring device, and a state of charge monitoring device.

48. A storage battery including a system for monitoring a state of the battery comprising:
a first cover;
a second cover coupled to the first cover and including an electronic device;
a wire coupled to the electronic device; and
at least one clip coupled to the wire and to a secondary battery terminal.

49. The storage battery of claim 48, wherein the second cover is coupled to the first cover by a heat seal.

50. The storage battery of claim 48, wherein the electronic device is configured for monitoring a state of charge of a battery.

51. The storage battery of claim 48, wherein the electronic device includes at least one of an alarm device, an anti-theft device, a state of health monitoring device, and a state of charge monitoring device.

52. The storage battery of claim 48, wherein the clip is integrally formed with the wire.

53. The storage battery of claim 48, wherein the clip includes at least one resiliently flexible member.

54. The storage battery of claim 48, wherein at least a portion of the clip is formed from a conductive material.

55. The storage battery of claim 48, wherein the clip is configured for maintaining electrical contact with the secondary battery terminal during the operation of a battery.

56. The storage battery of claim 48, wherein at least a portion of the clip is configured for flexing when the clip is attached to a battery terminal.
